(19) United States
(12) Patent Application Publication
(10) Pub. No.: US 2011/0232180 A1
(43) Pub. Date: Sep. 29, 2011

(54) Method of applying calcium magnesium acetate to affect growth of unwanted broadleaf weeds in lawn grasses

(76) Inventor: Shane Blake Schultz, SR., Dearborn Heights, MI (US)

(21) Appl. No.: 12/932,680

(22) Filed: Mar. 4, 2011

Related U.S. Application Data
(60) Provisional application No. 61/316,444, filed on Mar. 23, 2010.

(51) Int. Cl. A01G 1/00; A01N 37/02; A01P 13/00

(52) U.S. Cl. 47/58.1 R; 504/320

(57) ABSTRACT

The new art of the present invention is use of calcium magnesium acetate to affect broadleaf weeds, as a result of exposure. The method enhances the speed of effectiveness of elimination of certain broadleaf weeds. The non toxic substance can help protect the environment. The optional method of using a binding liquid to cause a better adhering of the granular form of calcium magnesium acetate to the leaves of an unwanted plant in lawn grasses and less rolling off of the grains when applied to the leaves. Grinding to smaller micron grains even as small as dust and then applying to the leaves to affect unwanted weeds wherein by reduction of weight which the standard sized grains add to the leaf, the grinding helps limit grain roll off and weight added to the leaf. The optional method of converting the calcium magnesium grains to a liquid form, then applying to the broadleaf weed, is an option. Any of the mentioned methods provides a fast elimination of the violet weed plants in desirable lawn grasses, with the intent of using these in my personal business practices as a lawn care professional.

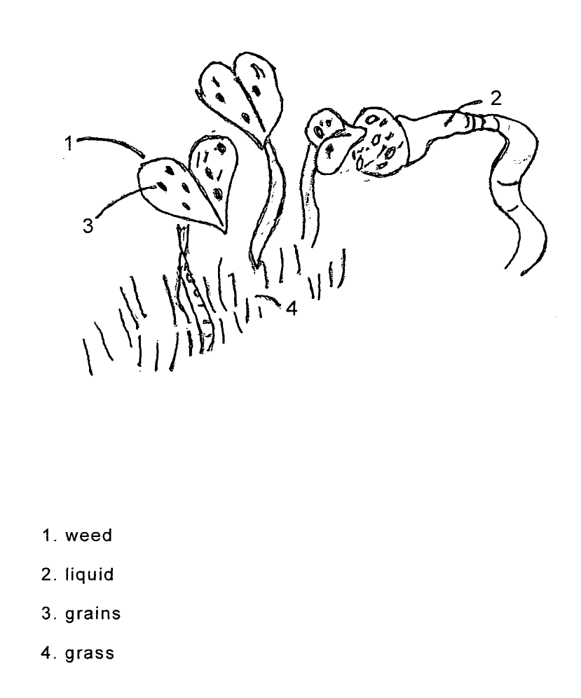

### CROSS REFERENCE TO RELATED APPLICATIONS

| | |
|---|---|
| U.S. Pat. No. 7,799,343 | Loughner |
| U.S. Pat. No. 4,511,485 | Gancy |
| U.S. Pat. No. 4,488,978 | Gancy |
| U.S. Pat. No. 6,756,341 | Grimm |
| WO 1990/015112 | Su |
| US 2009/0048112 | Elliott et. al |
| US 2007/0110909 | Isakoff et. al |
| US 2010/016158 | Killian et. Al |

The patent issued to Loughner—(U.S. Pat. No. 7,799,343—September 2010) discloses a need for safer control of broadleaf weeds and protecting the surrounding lawn grasses

The patent issued to Gancy (U.S. Pat. No. 4,511,485—Apr. 16, 1985) discloses a method of making calcium magnesium acetate.

The patent issued to Gancy (U.S. Pat. No. 4,488,978—Dec. 18, 1984) discloses a preferred particle size of calcium magnesium acetate to be an effective ice melt.

The patent issued to Grimm (U.S. Pat. No. 6,756,341—Jun. 29, 2004) discloses the use of a non-toxic weed killer, mainly sodium bicarbonate

The World patent application by Su (WO 1990/015112 Dec. 13, 1980) discloses a method for making bulk calcium magnesium acetate.

The remaining patents disclose a variety of other related art.

### BACKGROUND OF THE INVENTION

The present invention relates to a non toxic weed control treatment to eliminate selected broadleaf weed plants in lawn grasses. The use of Calcium magnesium acetate is well known in prior art, as a method to reduce ice, commonly referred to as an ice melt, and a alternative to rock salt. Used mostly, as an ice melt on roadway type surfaces, due to the negligiole risk to the environment. The grain size is important according to the patent issued to Gancy U.S. Pat. No. 4,488,978 December 1984 where as, use of calcium magnesium acetate in a very fine grain or dust is not desirable in ice melt, because it is virtually ineffective if attempting to try and dust the ice, per se, to melt the target. Therefore, a thick coarse grain is desirable in the purpose of ice melting.

What is not common knowledge is that calcium magnesium acetate is an effective weed control and or when used in a method has little or no adverse affect to surrounding lawn grasses. Here, a smaller grain size can be important. Generally, when placing standard ice melt sized calcium magnesium grains, onto a weed leaf, as a weed control treatment, the ice melt sized grains tend to bend the leaf in order to release the over burden of weight. Due to the fact, that there are few non toxic weed control products known to be really effective because they tend to take longer then the toxic products, available on the market. It is important to continue to seek products which offer more options to consumers, such as, work faster and are less harmful to the environment. Once finding such a substance, it is important to overcome any obstacles and create a method for making it effective on a weed to accomplish the goal of eliminating the weed.

One object of this invention is to overcome the obstacles of the manufactured ice melt product calcium magnesium acetate in order to use it, as a non toxic weed control product to selectively eliminate certain broadleaf weeds, in a faster and safer way.

### BRIEF SUMMARY OF THE INVENTION

The present invention involves reduction of unwanted weed plants in lawn grasses, more specifically, a method of applying calcium magnesium acetate to unwanted broadleaf weed plants in lawn grasses. As a business practice and different use of calcium magnesium acetate, known in prior art, as a deicing product for roadways and runways. The present can, also be an effective non toxic weed control with little or no adverse affect to surrounding lawn grasses. Healthy lawn grass turf is desired by some property owners, most use a variety of available products to reduce unwanted weeds in lawn grasses. Use of calcium magnesium acetate can be less harmful to the environment then the known toxic products that are available for lawn weed control treatments.

Calcium magnesium acetate is non-toxic to the environment. The present relates to use of calcium magnesium acetate in a new application method, as a weed eliminator. This new method could utilize calcium magnesium acetate in the granular or liquid form. The preferred method can eliminate broadleaf weeds by placing several grains of calcium magnesium acetate on each emerged leaf. To assist in this method, a binding agent, referred to in this application, as a binder, can be applied to each leaf, just prior to applying the calcium magnesium acetate grains. The binder, a liquid, such as water, works to help, in temporary adhesion, of the grains of calcium magnesium acetate to the leaves of the unwanted weed. Converting calcium magnesium acetate grains to finer micron particles, then in known prior art, where it is known as an ice melt product and or converting the grains to a liquid form and then applying to the weeds can be effective alternative methods, as described.

### BRIEF DESCRIPTION OF SEVERAL VIEWS OF THE DRAWING

### One Drawing Page

The drawing page depicts several heart shaped broadleaf weed leaves of a violet weed plant growing in a typical lawn grass section. A optional two step process wherein, step one is the introduction of a binder liquid and step two adding the grains of the calcium magnesium acetate placed on top of the leafs of the weeds.

### DETAILED DESCRIPTION OF THE INVENTION

Use of calcium magnesium acetate can be effective in a treatment of lawn grasses to affect growth of broadleaf weeds.

Calcium magnesium acetate is primarily, a well known alternative to rock salt in the de-icing of road surfaces. The Federal Aviation administration has approved this, for use as a de-icing agent, for Airport runways. Airports often contain miles of road surfaces accompanied by grassy borders. When choosing a deicing solution, the administration considers many factors. Reduction of roadway deterioration is a factor as well as, environmental protection of the surrounding grassy areas along runways, among others. The noted concerns are of the highest importance. Calcium magnesium acetate is non toxic to the environment. The general public also, uses calcium magnesium as a deicing agent for walkway, driveway and other roadway surfaces at commercial and residential interests. This has less effect on cement deterioration, less then, common rock salt. Typically, the granular substance dissolves into the surrounding grasses, after serving the ice melting purpose, with very minimal to no risk to the grasses. Grain size in ice melting is important, as shown in prior art. Grain size in ice melting affects the ability of the calcium magnesium acetate to melt ice on roadway surfaces.

A novel unknown use of calcium magnesium acetate is as an effective eliminator of certain broadleaf weeds which invade lawn grasses. When applying the granular substance to the leaves of the weeds, it can produce desired results, very quickly, much faster then many previously known toxic compositions. This method can work in as little as two days. In addition, many herbicides must be continually applied each lasting approximately a month, to achieve or maintain comparable weed reducing results.

Problems of simply applying calcium magnesium acetate grains of the ice melting size can also occur. The present method addresses these, first, the grains of the calcium magnesium acetate, do not naturally adhere themselves to the leaves of broadleaf weed plants, whereas, using an optional method a liquid binder is applied to assist in adhering the grains to the leaves in this application.

Secondly, applying heavy, ice melt size grains of calcium magnesium acetate, can bend the leaves due to added weight from the grains causing grain roll or falling off from the surface of the leaves.

Thus, the preferred method over comes these obstacles by using a liquid binder, such as water, applied to the leaves, prior to sprinkling the intentionally reduced size calcium magnesium acetate grains onto the weed leaf surfaces. These are not mandatory steps, it simply helps reduce fall off of the grains on the leaves. Alternatively, without the binder and size reduction, the grains could rest by simple placement on the leaves of the weed. The addition of the binder and alteration of the calcium magnesium acetate grains simply helps the method in being more effective.

By limiting the amount or number of grains and or reducing grain size of particles which are sprinkled upon each leaf of the unwanted plant and or with a liquid binder present, roll off or falling off of the grains, does not occur as often. Due mostly to the wet binder causing a temporary adhesion of the calcium magnesium acetate grains to the leaves of the weed and grains are normally a standard size when sold as an ice melt product, which can be too heavy for the weed leaf. Grinding the calcium magnesium acetate into a smaller particle micron is the preferred option, in order to reduce weight added to the leaves of the unwanted weed, after the optional binder is applied. This can provide a more uniform coverage of the leaves of the target plant and reduce weight applied on the target weed which, standard sized grains might cause.

Therefore, the present invention offers multiple options for more effective results in applying calcium magnesium acetate as a broadleaf weed eliminator. Converting the calcium magnesium acetate to a liquid form through any method, including, but not limited to crushing the grains in order to extract liquid, heating the grains to extract liquid, generally causing a release of liquid from the grains, which can be applied to broadleaf weeds, or adding a small amount of liquid to the grains, water for instance, in order to soak the grains in the said liquid, to assist the dissolve process are all options, among others.

The liquid created could be applied to the leaves of the weed directly, or mixed with another liquid, in ratios to determine proper consistency for the best effect on selected plants.

Briefly, my experience comes from years in the lawn care industry, as a lawn care professional. I became interested in better serving customers, finding more natural and or non toxic methods to control unwanted plant weeds in lawn grasses. Yet, I was required to use the products which my employer supplied, due to EPA guidelines. Some were known toxins. In fact, I was personally harmed by toxin based lawn care products, during my employment.

In addition, many customers regularly told me they were concerned about the potential unknown hazard of chemical applications to family and the environment. One common lawn care application technique of controlling weeds in lawn grasses involves using liquid application to cover large areas and or all areas of lawn grasses using the liquid herbicide products. This liquid treatment is described as being spread in a blanket application to target pre and post emerged weeds and crab grasses. Applicators experienced frequent chemical exposure, and sometimes over exposure to the professional lawn and toxic chemicals used. Blanket spraying can be effective, most often need to be regularly applied, about once a month, but spreads unnecessary chemicals into the environment and often times in places where weeds do not exist.

When treating weeds, one common and resilient type of plant considered to be a weed, in lawn grasses is of the violet family of plants, violet weeds can be very aggressive and invade lawn grasses, especially in thin areas of the grass and can be unsightly in a well manicured lawn. Typically, violet weeds move into a small area of a lawn and then spread in places where the lawn is thin. Thin areas of lawn can be caused by many different problems including disease and insect indicators. Violets have a distinct and broad heart-shape leaf, and in general grow in bunches of leaves which can, when mature, produce flowers in a variety of colors, purple flower is most common, thus the name violet. The violet is a hearty and also, very resistant weed to most known toxic chemical products used in lawn care. The violet has a well known reputation as one of the toughest weeds to control in lawn care. The calcium magnesium acetate grains eliminate the plant, in as little as two days, much faster acting, then the best known products, generally used by lawn companies for violets.

The best known product to have an affect on violets is the product triclopyr, more commonly known by the commercial name turflon ester. The product has limited affect after one treatment but, can take several monthly treatments just to control the spread of the violet plants in lawn grasses. Triclopyr is a registered systematic herbicide of the pyridine group of herbicides. The registered product produces tricloropyridine which is a by product that can remain in the soil for up to a year and has been found to lower testosterone in men. This is generally mixed with other liquids in batch combinations. Triclopyr is considered slightly toxic to the environment, ducks and fish. All aspects of the product are documented, including registration with the environmental protection agency, EPA, documentation for transporting and use on lawn grasses. All treatments using triclopyr must be carefully documented. The triclopyr product has shown, in some cases to produce marginal results, due to several reasons including the way it is applied by an application specialist and the high rate of application necessary as sited in the patent issued to Loughner U.S. Pat. No. 7,799,343 Sep. 21, 2010. Once a month, I would apply the triclopyr product in liquid form to lawns with violet weeds and most often it took several monthly treatments just to diminish part of the plant. As portions of the plants died, other portions grew in thicker, requiring repeat applications.

Secondly, triclopyr was only applied in certain atmospheric temperatures, in ranges well below ninety degrees Fahrenheit. Caution was used due to the potential burning affect to the surrounding wanted lawn grasses during hot weather. These factors prompted the hearty violet plant to grow stronger and or more aggressively during the long hot season gaps between treatments.

Six months after leaving lawn care employment, I started to get small bunches of violet weeds in my own lawn. I did not have access to professional lawn products turflon ester. Generally, in my state you must be a licensed lawn care company to apply this product.

Local lawn and garden retailers had products under various names, but, no product was found to directly target violets only.

I certainly did not like the affect the professional products had on me and also, had concerns about the unknown affect it might have on my family. That is when I started to seek other ways to get rid of the violet plants in my lawn. I began to seek ways that would work quicker, be less harmful to humans and better for the environment. The violet plant in lawn grasses is widely distributed, throughout the US. I found that calcium magnesium acetate grains worked to control violet weeds in as little as two days, much faster then any other known product and it is non toxic to the environment. No alteration of the actual existing ice melt calcium magnesium acetate product was necessary to affect the broadleaf weeds, but due to the weight of each grain applied to the leaves, most times the leaves would not hold the weight, well, drop the grains off the surface was common.

One reason why my present method is important, at least minimal grinding of the grains to a smaller micron is desirable, to overcome this problem.

Extreme, over applications of the granular calcium magnesium acetate did affect common lawn grasses, but because no other product really works well against violet weeds and no known non toxic product works on the violet weed, a method was developed. This method serves good purpose because it causes little or no adverse affect to the lawn grasses around or near the violet weeds. The preferred method of application for my invention involves using a potential device to apply or by hand sprinkling grains onto leaves of the plant to isolate the product on the target weed. Some grains may fall into the surrounding grasses, but, limiting the amount of grains released, can eliminate any adverse affects to the immediate grass area. Applying the grains, after a binder is sprayed on the leaves, such as applying water directly onto the broadleaf weed leaves, then sprinkling the grains onto the leaves is the most effective method.

This binder step is however, an optional step. To affect the plant with the calcium magnesium acetate grains simply need to be exposed to the weed leaves.

The binder does serve, at least, but not limited to, these two purposes
1) The binder liquid helps secure the grains in place, where they land on the surface of each leaf
2) The binder liquid helps assist in elimination of the violet weed,
   The combination of binder, water for instance, and calcium magnesium acetate grain are exposed to the leaf of the weed, the water helps the grains dissolve into the leaf, more rapidly.

Quantities of grains per leaf, needed for minimal results can range from crushed calcium magnesium acetate grains to a fine dust like micron, to 1 or more CMA grains of the standard size known ice melt in prior art, per leaf or more. Leaf size can play a factor in determining whether to add more grains to attempt to provide better results in the method.

As previously stated, a liquid conversion, extracting liquid from the grains is another potential method.

All of these would be slightly more time consuming then professional services, using liquid blanket type applications. Yet, that is of little adverse consequence, when compared to the speed in which calcium magnesium acetate eliminates the weed plants and the safety of use, over other known herbicides on the market which affect violet weed. Many homeowners seek non toxic methods due to the environmental concerns.

There are several advantages and reasons why the present is useful over those products currently known, on the market, not limited to
a) Being non toxic the remedy will remain in the market, indefinitely;
b) The speed in which this works and the ease of applying through directions, of the preferred method
c) the safer ingredients are appealing to customers and the environment, personal protection equipment (PPE), a PPE is normally needed for toxic herbicide applications are not needed when using calcium magnesium acetate.
d) Calcium magnesium acetate is an ice melt and seasonal product. It would also, appeal to current manufacturers.
e) By adding a new use, which turns calcium magnesium acetate into an all year sales product, as opposed to, a seasonal product sold mostly when winter nears, in it's current market use.
   This could increase streams of revenue through increased production levels, during off peak seasons.

In the future, I intend to use this as a weed eliminator for violets in my customer lawns as a personal business practice.

Calcium magnesium acetate is a registered non toxic ice melt product (CMA) CAS-76123-46-1. Not to be confused with a similar abbreviation code used for a crab grass control product in lawns (CAMA also, sometimes referred to as CMA) CAS-5902-95-4 calcium acid methanearsonate which is a toxic chemical from the cacodylic acid group of chemicals.

I claim:

1. A lawn treatment method and system as substantially described in the specification and drawings provided herewith.

2. A lawn treatment method comprising the steps of:
providing a non-toxic, granular calcium magnesium acetate; and applying the granular calcium magnesium acetate to a leaf on a broadleaf weed, wherein the broadleaf weed is diminished through exposure to the calcium magnesium acetate.

3. The lawn treatment method of claim 2, further comprising the step of applying a binder to the leaf of the broadleaf weed prior to the application of the granular calcium magnesium acetate.

4. The lawn treatment method of claim 3, wherein the binder includes water.

5. The lawn treatment method of claim 2, wherein the step of providing the granular calcium magnesium acetate includes crushing the grains to a grain size sufficient for the calcium magnesium acetate to adhere to the leaves of the broadleaf weed with the binder, and the granular calcium magnesium acetate is substantially evenly dusted atop the leaf of the broadleaf weed during the application.

6. The lawn treatment method of claim 5, wherein the calcium magnesium acetate is crushed to a fine dust for dusting the leaf of the broadleaf weed.

7. The lawn treatment method of claim 2, wherein the broadleaf weed belongs to the violet family of broadleaf weeds.

8. The lawn treatment method of claim 2, wherein the granular calcium magnesium acetate is dissolved into a solution and the solution is applied to the leaf on the broadleaf weed.
